(19) United States
(12) Patent Application Publication
(10) Pub. No.: US 2014/0164069 A1
(43) Pub. Date: Jun. 12, 2014

(54) Generating Global Optimized Strategies For Information Requests, Proposals, And Statements of Work Within a Time Period Across Hierarchical Entity Boundaries

(71) Applicant: INTERNATIONAL BUSINESS MACHINES CORPORATION, Armonk, NY (US)

(72) Inventors: David J. Allard, Boynton Beach, FL (US); Robert R. Friedlander, Southbury, CT (US); Richard Hennessy, Austin, TX (US); James R. Kraemer, Santa Fe, NM (US)

(73) Assignee: INTERNATIONAL BUSINESS MACHINES CORPORATION, Armonk, NY (US)

(21) Appl. No.: 13/706,719

(22) Filed: Dec. 6, 2012

(51) Int. Cl. G06Q 10/06

(52) U.S. Cl. CPC G06Q 10/06375
USPC 705/7.37

(57) ABSTRACT

A method, system and computer program product for determining a response to a sales event within a time period with information which spans across hierarchical entity boundaries of a company. The method detects a sales event and determines requirements of the sales event, parties involved and resource area of the sales event. If the resource area is not supported by the company, return to detecting another sales event without responding to the sales event. If the area is supported by the company, initiating a sales resource optimization to determine an optimized resource package to respond to the sales event and determining a likelihood of the company being awarded the sales event based on the optimized resource package. If the likelihood of the company being awarded the sales event based on the optimized resource package is greater than a predetermined probability, responding to the sales event with the optimized resource package.

### BACKGROUND

The present invention relates to sales strategies for analyzing and determining a response to an information request, proposal and/or statement of work, and more specifically to generating global optimized strategies for determining a response to an information request, proposal, and statements of work within a time period with information which spans across hierarchical entity boundaries.

Sales staff can have a difficult time determining whether the company they work for should put time and money towards responding to a sales opportunity or sales event. A sales event is an occasion in which there is an opportunity to provide a response to a set problem or set of requirements to satisfy a client or customer. Often times, companies respond to any and all sales opportunities or sales events regardless of whether the company is in a position to “win” or be “awarded” the sales event, resulting in wasted resources, missed opportunities to respond to other sales events, dissatisfied staff, under serving existing customers, and a negative perception of the company's ability to satisfy customer's requirements. The wasted resources can potentially impact client satisfaction due to distraction of preparing the response to the sales event. The missed sales opportunities or sales events that the company could have satisfied can result in lost revenue.

### SUMMARY

According to one embodiment of the present invention a method for determining a response to a sales event within a time period with information which spans across hierarchical entity boundaries of a company. The method comprising: a) detecting a sales event; b) determining requirements of the sales event, parties involved and resource area of the sales event; c) if the resource area is not supported by the company, returning to step (a) without responding to the sales event; d) initiating a sales resource optimization to determine an optimized resource package to respond to the sales event; e) determining a likelihood of the company being awarded the sales event by the parties involved based on the optimized resource package; f) if the likelihood of the company being awarded the sales event based on the optimized resource package is greater than a predetermined probability, responding to the sales event with the optimized resource package; and g) returning to step (a) to detect another sales event.

According to another embodiment of the present invention, a computer program product for determining a response to a sales event within a time period with information which spans across hierarchical entity boundaries of a company. The computer program product comprising: one or more computer-readable, tangible storage devices; a) program instructions, stored on at least one of the one or more storage devices, to detect a sales event; b) program instructions, stored on at least one of the one or more storage devices, to determine requirements of the sales event, parties involved and resource area of the sales event; c) if the resource area is not supported by the company, program instructions, stored on at least one of the one or more storage devices, to return to program instructions (a) without responding to the sales event; d) program instructions, stored on at least one of the one or more storage devices, to initiate a sales resource optimization to determine an optimized resource package to respond to the sales event; e) program instructions, stored on at least one of the one or more storage devices, to determine a likelihood of the company being awarded the sales event by the parties involved based on the optimized resource package; f) if the likelihood of the company being awarded the sales event based on the optimized resource package is greater than a predetermined probability, program instructions, stored on at least one of the one or more storage devices, to respond to the sales event with the optimized resource package; and g) program instructions, stored on at least one of the one or more storage devices, to return to program instructions (a) to detect another sales event.

According to another embodiment of the present invention, a system for determining a response to a sales event within a time period with information which spans across hierarchical entity boundaries of a company. The system comprising: one or more processors, one or more computer-readable memories and one or more computer-readable, tangible storage devices; program instructions, stored on at least one of the one or more storage devices for execution by at least one of the one or more processors via at least one of the one or more memories, to a) program instructions, stored on at least one of the one or more storage devices for execution by at least one of the one or more processors via at least one of the one or more memories, to detect a sales event; b) program instructions, stored on at least one of the one or more storage devices for execution by at least one of the one or more processors via at least one of the one or more memories, to determine requirements of the sales event, parties involved and resource area of the sales event; c) if the resource area is not supported by the company, program instructions, stored on at least one of the one or more storage devices for execution by at least one of the one or more processors via at least one of the one or more memories, to return to program instructions (a) without responding to the sales event; d) program instructions, stored on at least one of the one or more storage devices for execution by at least one of the one or more processors via at least one of the one or more memories, to initiate a sales resource optimization to determine an optimized resource package to respond to the sales event; e) program instructions, stored on at least one of the one or more storage devices for execution by at least one of the one or more processors via at least one of the one or more memories, to determine a likelihood of the company being awarded the sales event by the parties involved based on the optimized resource package; f) if the likelihood of the company being awarded the sales event based on the optimized resource package is greater than a predetermined probability, program instructions, stored on at least one of the one or more storage devices for execution by at least one of the one or more processors via at least one of the one or more memories, to respond to the sales event with the optimized resource package; and g) program instructions, stored on at least one of the one or more storage devices for execution by at least one of the one or more processors via at least one of the one or more memories, to return to program instructions (a) to detect another sales event.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a schematic of an overview of the system for generating global optimized strategies to determine a response to a sales event which may include information requests, proposals, and statements of work, within a time period with information which spans across hierarchical entity boundaries.

FIG. 3 shows a schematic of a system for finding and organizing requirements, resources and responses for use during optimization routines in the system of FIG. 2.

FIG. 4 shows a schematic of a system for finding and organizing routes associated with responses for use during optimization routines in the system of FIG. 2.

FIG. 5 shows a schematic of a system for predicting the likelihood of being awarded the sales event for use during optimization routines in the system of FIG. 2.

FIG. 6-7 shows a flowchart of a method for generating global optimized strategies to determine a response to an information requests, proposals, and statements of work within a time period with information which spans across hierarchical entity boundaries.

FIG. 8 shows a flowchart of a method of initiating sales resource optimization to determine an optimized resource package to present in response to a sales event.

FIG. 9 illustrates internal and external components of a client computer and a server computer in which illustrative embodiments may be implemented.

### DETAILED DESCRIPTION

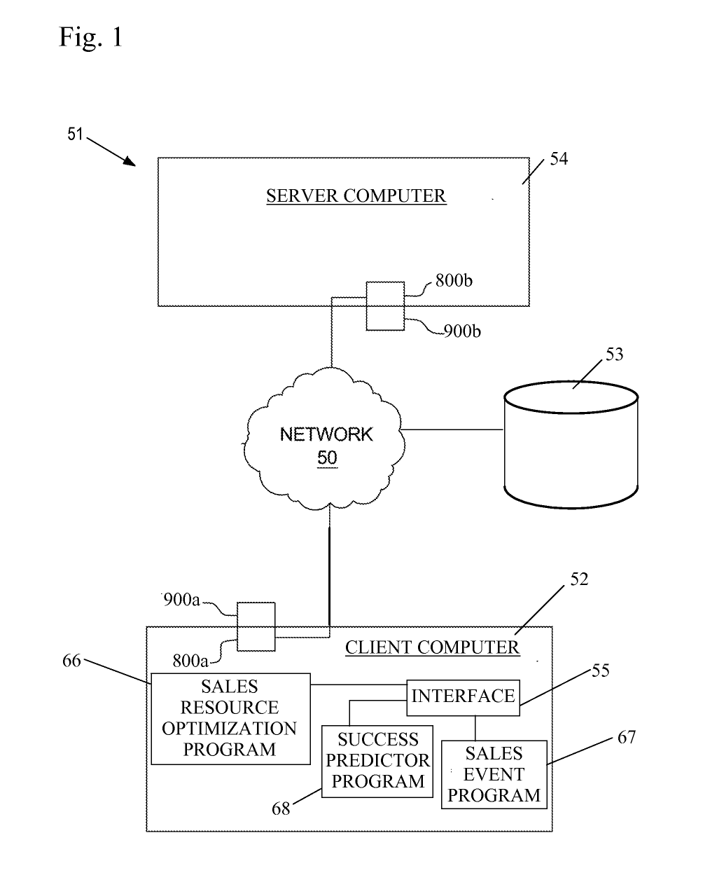

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

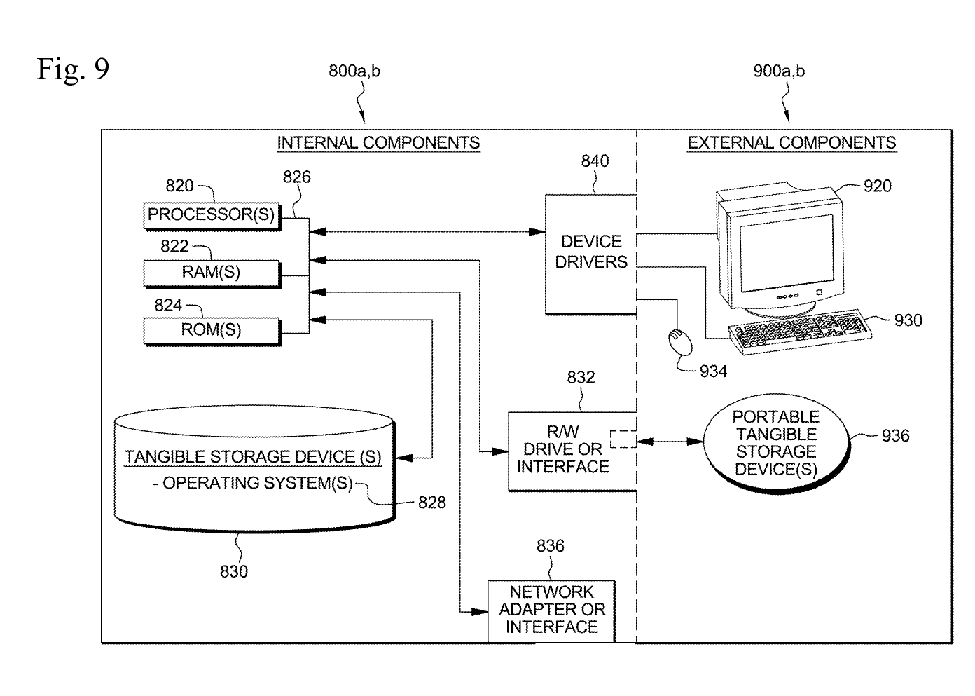

In the depicted example, a client computer 52, server computer 54, and a repository 53 connect to network 50. In other exemplary embodiments, network data processing system 51 may include additional client computers, storage devices, server computers, and other devices not shown. The client computer 52 includes a set of internal components 800a and a set of external components 900a, further illustrated in FIG. 9. The client computer 52 may be, for example, a mobile device, a cell phone, a personal digital assistant, a netbook, a laptop computer, a tablet computer, a desktop computer, a sequencing machine or any other type of computing device.

Client computer 52 may contain an interface 55. The interface can be, for example, a command line interface, a graphical user interface (GUI), or a web user interface (WUI). The interface may be used, for example for viewing resources, resource skills, sales resource optimization packages, predictability statistics, mapping of resources to industry solution ontology, and sales events. The interface may also accept an input regarding a predetermined predictability statistic, or information which aids in the generation of the sales resource optimization package.

In the depicted example, server computer 54 provides information, such as boot files, operating system images, and applications to client computer 52. Server computer 54 can compute the information locally or extract the information from other computers on network 50. Server computer 54 includes a set of internal components 800b and a set of external components 900b illustrated in FIG. 9.

Program code and programs such as a sales event program 67, a sales resource optimization program 66, and a success predictor program 68 may be stored on at least one of one or more computer-readable tangible storage devices 830 shown in FIG. 9, on at least one of one or more portable computer-readable tangible storage devices 936 as shown in FIG. 9, or repository 53 connected to network 50, or downloaded to a data processing system or other device for use. For example, program code, a sales event program 67, a sales resource optimization program 66, and a success predictor program 68 may be stored on at least one of one or more tangible storage devices 830 on server computer 54 and downloaded to client computer 52 over network 50 for use on client computer 52. Alternatively, server computer 54 can be a web server, and the program code, a sales event program 67, a sales resource optimization program 66, and a success predictor program 68 may be stored on at least one of the one or more tangible storage devices 830 on server computer 54 and accessed on client computer 52. Sales event program 67, sales resource optimization program 66, and success predictor program 68 can be accessed on client computer 52 through interface 55. In other exemplary embodiments, the program code and programs such as a sales event program 67, a sales resource optimization program 66, and a success predictor program 68 may be stored on at least one of one or more computer-readable tangible storage devices 830 on client computer 52 or distributed between two or more servers.

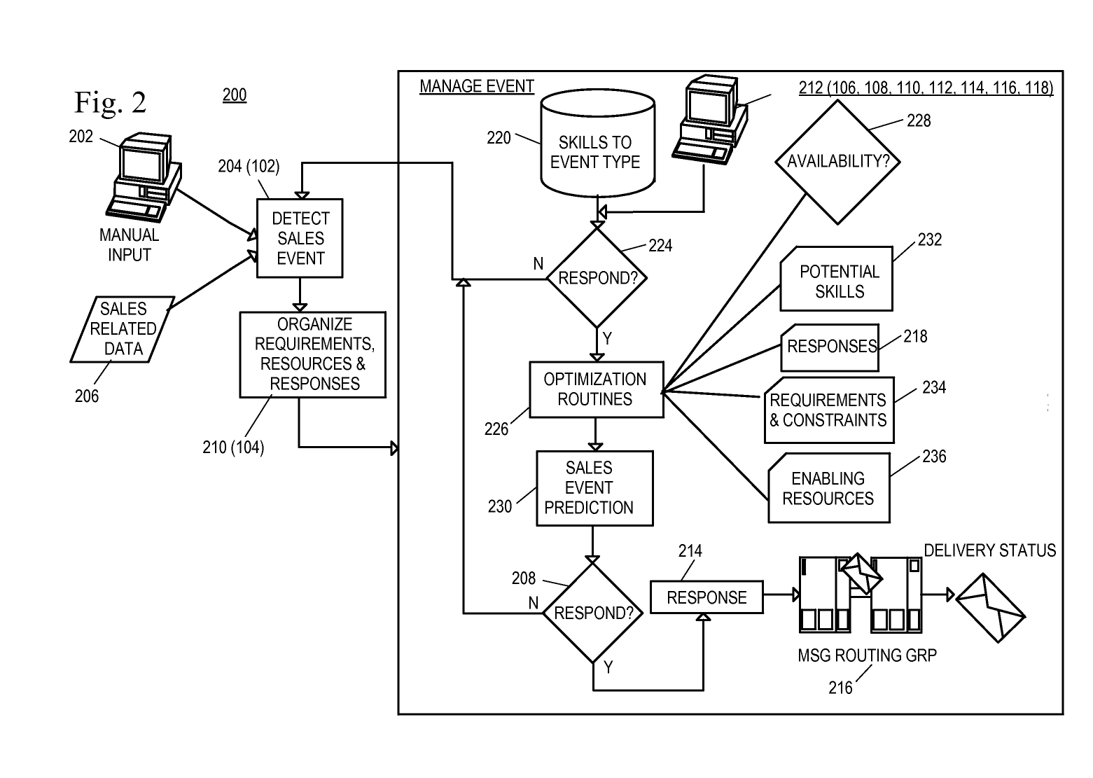

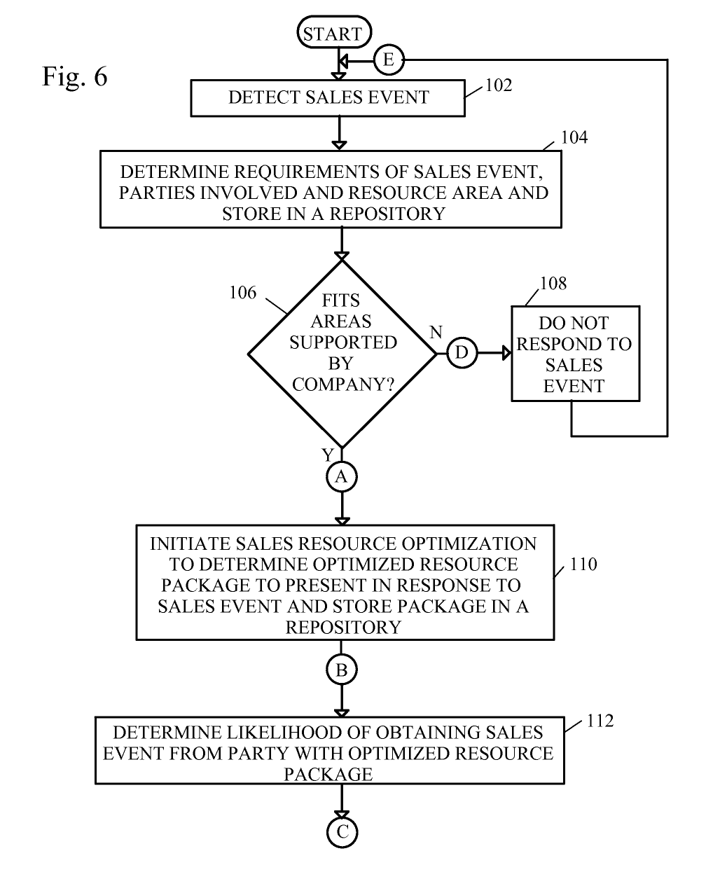

FIG. 2 shows a high level overview of a system for generating global optimized strategies for information requests, proposals, and statements of work within a time period across hierarchical entity boundaries. A sales event is an occasion in which there is an opportunity to provide a response to a set problem or set of requirements to satisfy a client or customer. The sales event is usually open to receiving responses for a short period of time. FIGS. 6-8 show a flowchart, to which the numbered steps below refer.

A sales event is detected 204 (step 102) from manual input 202 and/or sales related data 206 that may be monitored. The requirements, resources and previous responses to the sales event are organized 210 (step 104) and the sales event is then managed 212 (steps 106, 108, 110, 112, 114, 116, 118) to determine in a response should be made to the sales event and if so, what response. The management of the sales event 212 includes a decision 224 whether to respond to the sales event based on the area or event type of the sales event within input from a repository of a company's skills in a specific area 220 as well as any manual input 222. If a decision is made not to respond, the system returns to detecting sales events 204. If a decision is made to respond, optimization routines 226 are run taking into account potential skills 232, requirements and constraints 234, enabling resources 236, availability of skills and resources 228, and past or present responses 218.

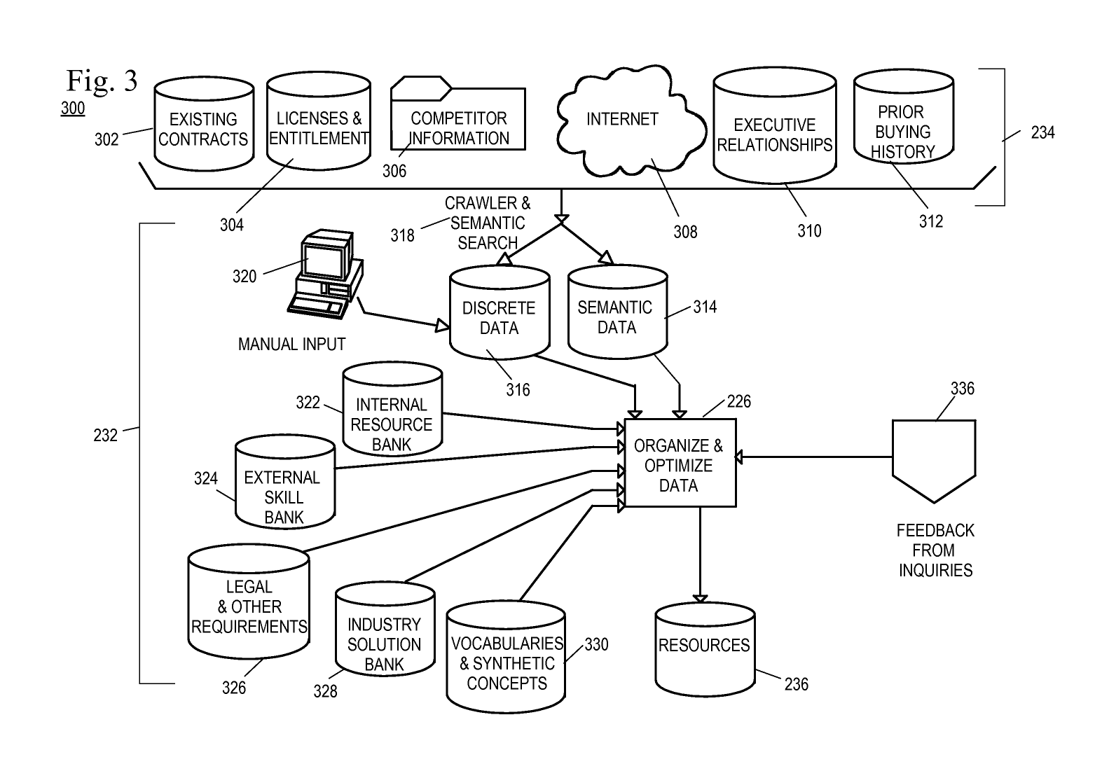

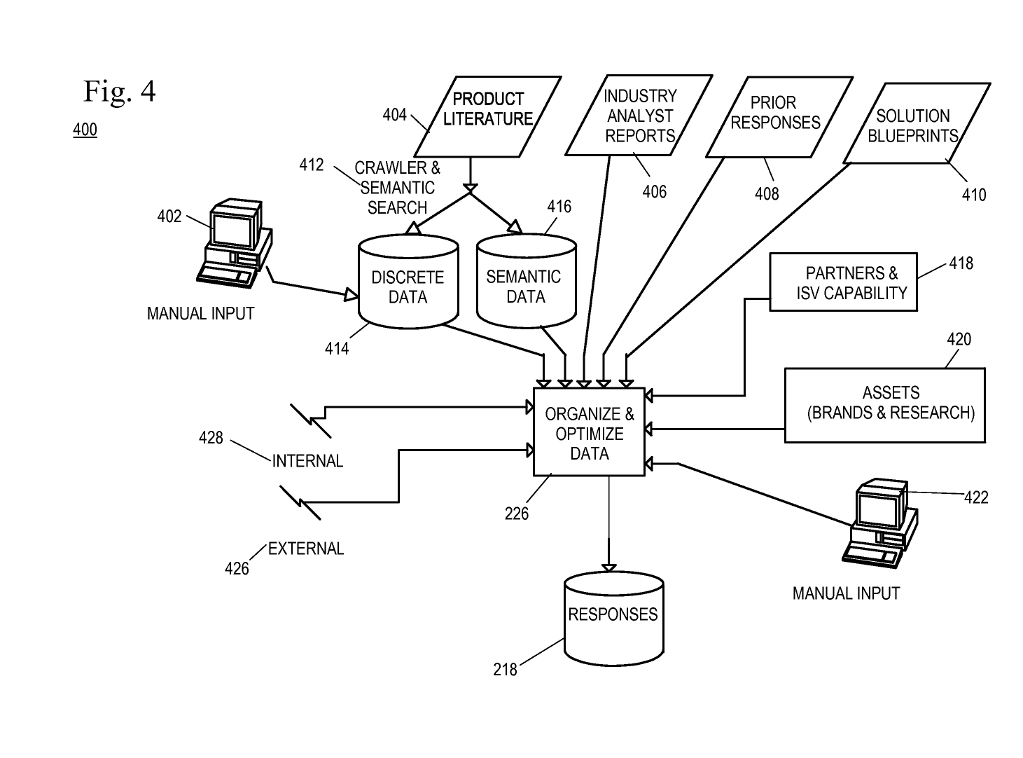

The generation of the enabling resources 236 is shown in FIG. 3. During the optimization routines 226, a response 218 that may be part of an optimized resource package is produced. The data that may be used to aid in generating responses 218 are shown in FIG. 4. Based on the optimization routine result of an optimized resource package, a sales event prediction 230 takes place to determine whether the likelihood of being awarded the sales event.

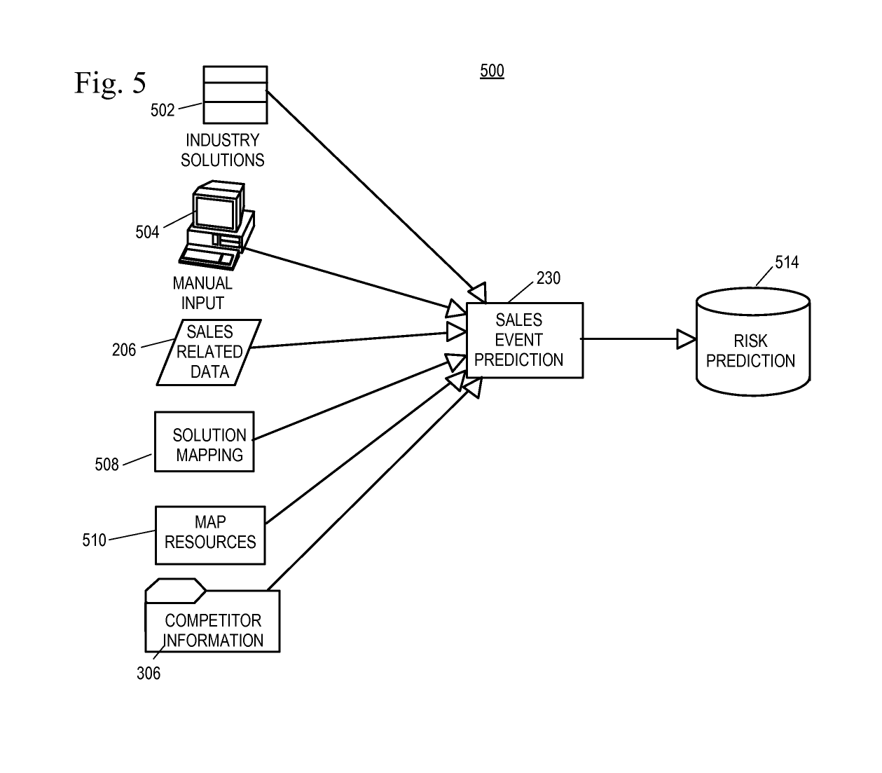

The sales event prediction system is shown in FIG. 5. This prediction 230 aids in determining whether a response is necessary to the sales event. If the prediction indicates that there is a low probability that the company will not be awarded the sales event, the system returns to monitoring sales events 204. If the prediction indicates that there is a high probability that the company will be awarded the sales event, the optimized resource package is sent onto a message group to appropriately handle responding to the sales event. Any feedback from a message group will update the system, including organization of the requirements, resources and responses 210 and how the sales events are managed 212.

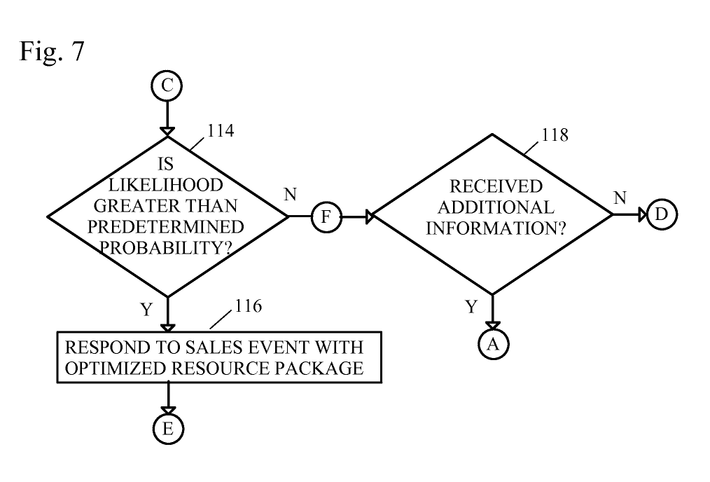

FIGS. 6-7 show a method for generating global optimized strategies for information requests, proposals, and statements of work within a time period across hierarchical entity boundaries with the system of FIG. 2.

In a first step, a sales event is detected (step 102). Next, requirements of the sales event, parties involved and resource area of the sales event are stored in a repository (step 104), for example by the sales event program 67. The sales event parameters, constraints and other information may be extracted by using advanced text analytics (ICPA) against known collateral sources. The known collateral sources may include, but are not limited to product specifications, prior request for proposals, statement of work, the company's deliverables, the company's service assets, and research assets. The collateral sources may also include external information from the company and can use state and government information, for example from government request for proposals and government requests for information. The collateral sources may be further expanded by the base knowledge of what resources and partners of the company supply.

The sales event constraints may include, but are not limited to, factors such as: client budget; previous buying behavior; competitor price point; competitor functionality; client account relationships, such as sponsorships; profit % or margin on other similar opportunities in the industry; degree of uplift on the margin required; resource availability; and legal requirements of the response, which can include non-compete requirements, jurisdiction licensing, warranties, indemnities, etc . . . The requirements may include the logistics of presenting a response to the sales event.

If the resource area of the sales event does not fit into an area which is supported by the company (step 106), the sales event is not responded to by the company (step 108) and the method returns to step 102 of detecting a sales event.

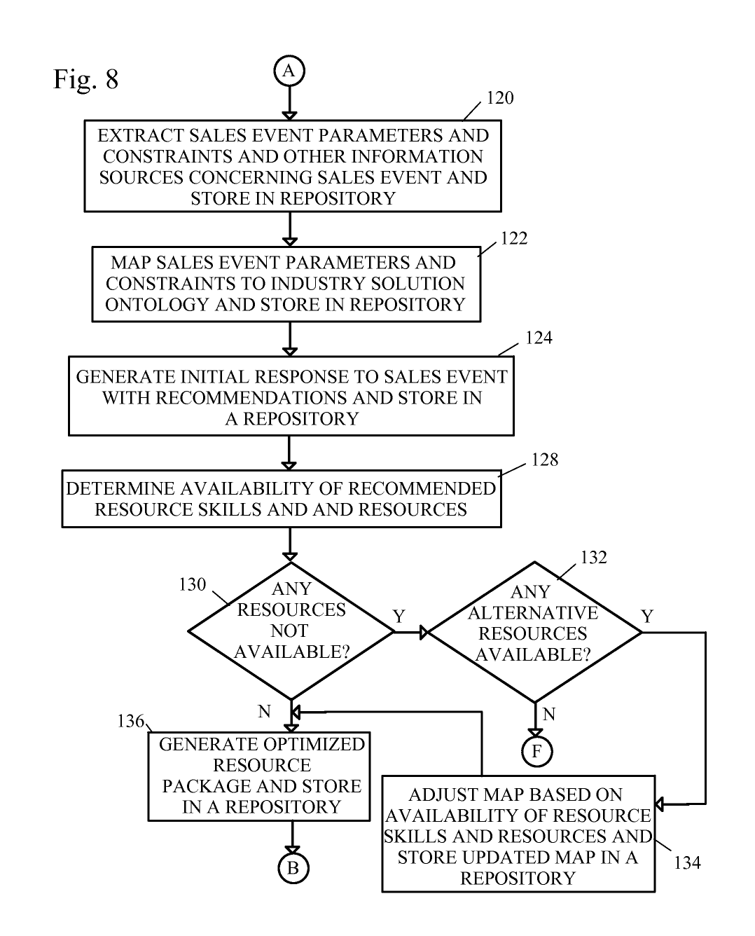

If the resource area of the sales event does fit into an area which is supported by the company (step 106), sales resource optimization is initiated to determine an optimized resource package to present in response to the sales event (step 110), for example by the sales resource optimization program 66. The optimized resource package determined in step 110 is stored in a repository, for example repository 53 of FIG. 1. The determination of an optimized resource package to present in response to the sales event based on available resources of the company is determined through steps 120-136 shown in FIG. 8.

A likelihood of obtaining or being awarded the sales event from the party with the optimized resource package is determined (step 112), for example by the success predictor program 68. If the likelihood of being awarded the sales event is not greater than a predetermined probability (step 114), and no additional information that might alter the optimized resource package has been received (step 118), then the sales event is not responded to by the company (step 108) and the method returns to step 102 of detecting a sales event. If additional information has been received (step 118), return to step 110 of initiating sales resource optimization.

If the likelihood of being awarded the sales event is greater than a predetermined probability (step 114), respond to the sales event with the optimized resource package (step 116) and then the method returns to step 102 of detecting a sales event.

FIG. 5 shows a schematic of a system for predicting the likelihood of winning the sales event 230, which takes place within the management of the sales event 212 and corresponds to steps 112 and 114 of FIGS. 6-7. A sales event prediction 230 outputs a risk prediction 514, in other words, the chances of winning or being awarded the sales event by receiving and considering input regarding industry solutions 502, manual input 504, sales related data 206, solution mapping 508, resource mapping 510, and competitor information 306.

Referring to FIG. 8, sales event parameters, constraints and other information sources concerning the sales event are extracted, for example by the sales resource optimization program 66, and stored in a repository (step 120). FIG. 3 shows a schematic of a system for finding and organizing requirements, resources and responses that take part in the optimization routines 226 of FIG. 2 and for step 120. Requirements and constraints 234 of the sales event and the company are searched 318. The requirements and constraints may include data repositories of existing contracts 302, licenses and entitlement 304, competitor information, other information mined from the Internet 308, executive relationships 310, and prior buying history 312.

The results of the crawler or semantic search 318, which mine the repositories of data, divides the results into a repository of discrete data 316 and semantic data 314. Manual input of additional data may be stored in the discrete data repository 316. The discrete data 316 and the semantic data 314 provide input to an organization of data process which is part of the optimization routine 226. Additionally, the organization of data process which is part of the optimization routine 226 may also receive input from potential skills of a company which can include data repositories of an internal resource bank 322, an external skill bank 324, legal and other requirements 326, an industry solution bank 328, vocabularies and synthetic concepts 330, and feedback from any inquiries, past or present 336. The organization of data process of the optimization routine 226 outputs the enabling resources 236 that are required to manage or respond to the sales event.

The sales event parameters and constraints are mapped to industry solution ontology and stored in a repository (step 122). Client deliverables, such as work products, project plans, solution blueprints, product literature, etc., are incorporated into the system to support continuous optimization of the sales resource package and build a knowledge model of the industry.

FIG. 4 shows a schematic of a system for finding and organizing responses, which take part in the optimization routines 226 of FIG. 2 and for step 122, within the management of the event 212. A crawler or semantic search 412 may take place to mine product literature 404 and divides the results into a repository of discrete data 414 and semantic data 416. Manual input 402 of additional data may be stored in the discrete data repository 414. The discrete data 414 and the semantic data 416 provide input to an organization of data process 210 that take part in the optimization routines 226. Additionally, the organization of data process 210, that take part in the optimization routines 226 may also receive input from industry analyst reports 406, prior responses 408, solution blueprints 410, partners and independent software vendor capabilities 418, assets 420 including brands and research, manual input 422, internal 428 or external 426 communication or other sources of information. The organization of data process 210, that take part in the optimization routines 226 outputs responses 218 that are required to manage or respond to the sales event.

The knowledge model may be used to impact solutions and product blueprints, such that functionality roadmaps based on this knowledge can be prioritized, to impact sales staffing and training programs based on trends within the market, to improve automation of sales response based on what is working, identification of processes that can be streamlined, and to identify gaps in a company's portfolio.

An initial response to the sales event based on steps 120 and 122 is generated and stored in a repository (step 124). By cataloging or extracting the parameters, constraints, requirements and other information from a sales event, and matching these parameters, constraints, requirements to known capabilities of a company, a high level or initial solution response to the sales event can be generated.

The initial solution response also includes a recommended preference with associated resource requirements including an order or magnitude and a monetary estimate to complete and provide the solution. The monetary estimate can also include a margin of error and an estimated monetary amount for additional components required to complete the solution.

The recommendations may include high level architecture, company business value proposition, software and hardware recommendations with initial sizing and pricing leverage, high level optimal work breakdown structure, intellectual property, resource spanning patterns, and other identifiers that would distinguish the company from other competitors and their responses to the sales event. The identifiers may be key contacts, asset availability, price point, infrastructure, resources, etc . . .

The company business value proposition may be based on return on investment, paybacks, net present value, and product specifications from prior related activities. The resource spanning patterns can include solution strategies, solution designs, implementation, testing, and on-going support. Furthermore, the recommendations consider existing company activities that may be leveraged.

The availability of recommended resources and resource skills from step 126 are determined (step 128). If there are resource or resource skills that are not available (step 130), and there aren't any alternative resources available to substitute (step 132), and no additional information received (step 118), then the sales event is not responded to by the company (step 108) and the method returns to step 102 of detecting a sales event.

If there are resource or resource skills that are not available (step 130), and there are alternative resources available to substitute (step 132), the map is adjusted based and stored in a repository (step 134). The method continues with step 136.

If the resources and resource skills are all available (step 130), the optimized resource package is generated (step 136).

FIG. 9 illustrates internal and external components of client computer 52 and server computer 54 in which illustrative embodiments may be implemented. In FIG. 9, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, a sales event program 67, a sales resource optimization program 66, and a success predictor program 68 are stored on one or more of the computer-readable tangible storage devices 830 for execution by one or more of the processors 820 via one or more of the RAMs 822 (which typically include cache memory). In the embodiment illustrated in FIG. 9, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A sales event program 67, a sales resource optimization program 66, and a success predictor program 68 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Sales event program 67, sales resource optimization program 66, and success predictor program 68 can be downloaded to client computer 52 and server computer 54 from an external computer via a network (for example, the Internet, a local area network or other, wide area network) and network adapter or interface 836. From the network adapter or interface 836, a sales event program 67, a sales resource optimization program 66, and a success predictor program 68 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Sales event program 67, sales resource optimization program 66, and success predictor program 68 can be written in various programming languages including low-level, high-level, object-oriented or non object-oriented languages. Alternatively, the functions of a sales event program 67, a sales resource optimization program 66, and a success predictor program 68 can be implemented in whole or in part by computer circuits and other hardware (not shown).

Based on the foregoing, a computer system, method and program product have been disclosed to generate global optimized strategies for determining a response to an information request, proposal, and statements of work within a time period with information which spans across hierarchical entity boundaries. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining a response to a sales event within a time period with information which spans across hierarchical entity boundaries of a company, the method comprising:
a) detecting a sales event;
b) determining requirements of the sales event, parties involved and resource area of the sales event;
c) if the resource area is not supported by the company, returning to step (a) without responding to the sales event;
d) initiating a sales resource optimization to determine an optimized resource package to respond to the sales event;
e) determining a likelihood of the company being awarded the sales event by the parties involved based on the optimized resource package;
f) if the likelihood of the company being awarded the sales event based on the optimized resource package is greater than a predetermined probability, responding to the sales event with the optimized resource package; and
g) returning to step (a) to detect another sales event.

2. The method of claim 1, wherein in step (f) if the likelihood of the company being awarded the sales event based on the optimized resource package is less than the predetermined probability, and additional information has been received, returning to the step (d) of initiating the sales resource optimization to determine the optimized resource package to respond to the sales event.

3. The method of claim 1, wherein step (d) comprises the steps of:
i) extracting from the sales event, at least sales event parameters, constraints and other information concerning responding to the sales event;
ii) mapping the extracted sales event parameters, constraints and other information concerning responding to the sales event to an industry solution ontology;
iii) generating an initial response to the sales event with skill and resource recommendations based on the mapping of the extracted sales event parameters, constraints and other information concerning responding to the sales event to an industry solution ontology;
iv) determining availability of the skills and resource recommendations; and
v) if all of the skills and resources recommended are available, generating an optimized resource package.

4. The method of claim 3, wherein in step (v) if any of the skills and resource recommended are not available and alternative skills and resources are available, adjusting the map based on the alternative skills and resources available, and continuing step (v) of generating the optimized resource package.

5. The method of claim 3, wherein in step (v) if any of the skills and resources recommended are not available, and alternative skills and resources are not available, and no additional information has been received, then returning to step (a) without responding to the sales event.

6. The method of claim 3, wherein in step (v) if any of the skills and resource recommended are not available, alternative skills and resources are not available, and additional information has been received, returning to step (d).

7. A computer program product for determining a response to a sales event within a time period with information which spans across hierarchical entity boundaries of a company, the computer program product comprising:
one or more computer-readable, tangible storage devices;
a) program instructions, stored on at least one of the one or more storage devices, to detect a sales event;
b) program instructions, stored on at least one of the one or more storage devices, to determine requirements of the sales event, parties involved and resource area of the sales event;
c) if the resource area is not supported by the company, program instructions, stored on at least one of the one or more storage devices, to return to program instructions (a) without responding to the sales event;
d) program instructions, stored on at least one of the one or more storage devices, to initiate a sales resource optimization to determine an optimized resource package to respond to the sales event;
e) program instructions, stored on at least one of the one or more storage devices, to determine a likelihood of the company being awarded the sales event by the parties involved based on the optimized resource package;
f) if the likelihood of the company being awarded the sales event based on the optimized resource package is greater than a predetermined probability, program instructions, stored on at least one of the one or more storage devices, to respond to the sales event with the optimized resource package; and
g) program instructions, stored on at least one of the one or more storage devices, to return to program instructions (a) to detect another sales event.

8. The computer program product of claim 7, wherein in program instructions (f), if the likelihood of the company being awarded the sales event based on the optimized resource package is less than the predetermined probability, and additional information has been received, program instructions, stored on at least one of the one or more storage devices, to return to the program instructions (d), stored on at least one of the one or more storage devices, to initiate the sales resource optimization to determine the optimized resource package to respond to the sales event.

9. The computer program product of claim 7, wherein program instructions (d) comprises the program instructions, stored on at least one of the one or more storage devices, to:
i) extract from the sales event, at least sales event parameters, constraints and other information concerning responding to the sales event;
ii) map the extracted sales event parameters, constraints and other information concerning responding to the sales event to an industry solution ontology;
iii) generate an initial response to the sales event with skill and resource recommendations based on the mapping of the extracted sales event parameters, constraints and other information concerning responding to the sales event to an industry solution ontology;
iv) determine availability of the skills and resource recommendations; and
v) if all of the skills and resources recommended are available, generate an optimized resource package.

10. The computer program product of claim 9, wherein in program instructions (v) if any of the skills and resource recommended are not available and alternative skills and resources are available, program instructions, stored on at least one of the one or more storage devices, to adjust the map based on the alternative skills and resources available, and continuing program instructions (v), stored on at least one of the one or more storage devices, to generate the optimized resource package.

11. The computer program product of claim 9, wherein in program instructions (v) if any of the skills and resources recommended are not available, and alternative skills and resources are not available, and no additional information has been received, then returning to program instructions (a), stored on at least one of the one or more storage devices, without responding to the sales event.

12. The computer program product of claim 9, wherein in program instructions (v) if any of the skills and resource recommended are not available, alternative skills and resources are not available, and additional information has been received, returning to program instructions (d).

13. A system for determining a response to a sales event within a time period with information which spans across hierarchical entity boundaries of a company, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to
a) program instructions, stored on at least one of the one or more storage devices for execution by at least one of the one or more processors via at least one of the one or more memories, to detect a sales event;
b) program instructions, stored on at least one of the one or more storage devices for execution by at least one of the one or more processors via at least one of the one or more memories, to determine requirements of the sales event, parties involved and resource area of the sales event;
c) if the resource area is not supported by the company, program instructions, stored on at least one of the one or more storage devices for execution by at least one of the one or more processors via at least one of the one or more memories, to return to program instructions (a) without responding to the sales event;
d) program instructions, stored on at least one of the one or more storage devices for execution by at least one of the one or more processors via at least one of the one or more memories, to initiate a sales resource optimization to determine an optimized resource package to respond to the sales event;
e) program instructions, stored on at least one of the one or more storage devices for execution by at least one of the one or more processors via at least one of the one or more memories, to determine a likelihood of the company being awarded the sales event by the parties involved based on the optimized resource package;
f) if the likelihood of the company being awarded the sales event based on the optimized resource package is greater than a predetermined probability, program instructions, stored on at least one of the one or more storage devices for execution by at least one of the one or more processors via at least one of the one or more memories, to respond to the sales event with the optimized resource package; and
g) program instructions, stored on at least one of the one or more storage devices for execution by at least one of the one or more processors via at least one of the one or more memories, to return to program instructions (a) to detect another sales event.

14. The system of claim 13, wherein in program instructions (f), if the likelihood of the company being awarded the sales event based on the optimized resource package is less than the predetermined probability, and additional information has been received, program instructions, stored on at least one of the one or more storage devices, to return to the program instructions (d), stored on at least one of the one or more storage devices for execution by at least one of the one or more processors via at least one of the one or more memories, to initiate the sales resource optimization to determine the optimized resource package to respond to the sales event.

15. The system of claim 13, wherein program instructions (d) comprises the program instructions, stored on at least one of the one or more storage devices for execution by at least one of the one or more processors via at least one of the one or more memories, to:
i) extract from the sales event, at least sales event parameters, constraints and other information concerning responding to the sales event;
ii) map the extracted sales event parameters, constraints and other information concerning responding to the sales event to an industry solution ontology;
iii) generate an initial response to the sales event with skill and resource recommendations based on the mapping of the extracted sales event parameters, constraints and other information concerning responding to the sales event to an industry solution ontology;
iv) determine availability of the skills and resource recommendations; and
v) if all of the skills and resources recommended are available, generate an optimized resource package.

16. The system of claim 15, wherein in program instructions (v) if any of the skills and resource recommended are not available and alternative skills and resources are available, program instructions, stored on at least one of the one or more storage devices for execution by at least one of the one or more processors via at least one of the one or more memories, to adjust the map based on the alternative skills and resources available, and continuing program instructions (v), stored on at least one of the one or more storage devices, to generate the optimized resource package.

17. The system of claim 15, wherein in program instructions (v) if any of the skills and resources recommended are not available, and alternative skills and resources are not available, and no additional information has been received, then returning to program instructions (a), stored on at least one of the one or more storage devices, without responding to the sales event.

18. The system of claim 15, wherein in program instructions (v) if any of the skills and resource recommended are not available, alternative skills and resources are not available, and additional information has been received, returning to program instructions (d).
